(19) United States
(12) Patent Application Publication
(10) Pub. No.: US 2026/0318405 A1
(43) Pub. Date: Oct. 15, 2026

(54) MODIFIED DOWNSHIFT RESPONSE

(71) Applicant: JAGUAR LAND ROVER LIMITED, Warwickshire (GB)

(72) Inventors: James MANNION, Whitley, Coventry, Warwickshire (GB); Tom OWEN, Whitley, Coventry, Warwickshire (GB); Robert CREAN, Whitley, Coventry, Warwickshire (GB); Sam JOHNSON, Whitley, Coventry, Warwickshire (GB)

(21) Appl. No.: 19/484,187

(22) PCT Filed: May 7, 2024
(86) PCT No.: PCT/EP2024/062636

§ 371 Date: Nov. 13, 2025

(30) Foreign Application Priority Data
May 15, 2023 (GB) 2307163.2

(51) Int. Cl. F16H 61/02; F16H 59/00; F16H 59/18; F16H 59/36; F16H 61/04

(52) U.S. Cl. CPC F16H 61/0213; F16H 59/18; F16H 59/36; F16H 61/04; F16H 2059/003; F16H 2059/183; F16H 2061/0227

(57) ABSTRACT

Aspects and embodiments of the invention relate to a control system (100), an automatic transmission system (10), a vehicle (1), a method (300), and computer readable instructions, for controlling an automatic transmission (12) of a vehicle (1), comprising: in a first mode, controlling (310) the automatic transmission (12) according to a first shift map (400) which defines downshift thresholds for a speed parameter as functions of accelerator input, wherein each downshift threshold is defined by a unique function; in a second mode, controlling (350) the automatic transmission (12) according to a second shift map (500) which defines downshift thresholds for the speed parameter as functions of accelerator input, wherein at least two downshift thresholds are defined by a common function; receiving (320) a signal indicative of a rate of increase in accelerator input; and switching (340) from the first mode to the second mode, in dependence on the rate of increase in accelerator input exceeding a threshold rate, and regardless of whether a downshift threshold of the first shift map (400) is crossed.

### TECHNICAL FIELD

The present disclosure relates to modified downshift response. Aspects of the invention relate to a control system, to an automatic transmission system, to a vehicle, to a method, and to computer readable instructions.

### BACKGROUND

It is known to provide automatic transmissions in vehicles. Automatic transmissions do not require input from a driver to shift gears. Gear management is instead provided to determine when it is appropriate to shift gear and what gear is appropriate to adopt in a given set of circumstances. In some circumstances, gear management may determine multiple appropriate gears in rapid succession. The adoption of each of these may compromise the accelerative performance of the vehicle.

### SUMMARY OF THE INVENTION

Aspects and embodiments of the invention provide a control system, an automatic transmission system, a vehicle, a method, and computer readable instructions as claimed in the appended claims.

According to an aspect of the present invention there is provided a control system for an automatic transmission of a vehicle comprising any one or more of the features described herein.

According to an aspect of the present invention there is provided a control system for an automatic transmission of a vehicle. The control system comprises one or more controllers. The control system configured to:
in a first mode, control the automatic transmission according to a first shift map which defines downshift thresholds for a speed parameter as functions of accelerator input, wherein each downshift threshold is defined by a unique function;
in a second mode, control the automatic transmission according to a second shift map which defines downshift thresholds for the speed parameter as functions of accelerator input, wherein at least two downshift thresholds are defined by a common function;
receive a signal indicative of a rate of increase in accelerator input; and
switch from the first mode to the second mode, in dependence on the rate of increase in accelerator input exceeding a threshold rate, and regardless of whether a downshift threshold of the first shift map is crossed.

An advantage of defining at least two downshift thresholds by a common function is that these at least two downshift thresholds can be crossed simultaneously, resulting in skipping intervening gear ratios. This results in more rapid adoption of a lower gear ratio where there is more mechanical advantage to aid vehicle acceleration. By triggering a switch to a shift map which defines at least two downshift thresholds by a common function based on the rate of increase in accelerator input rather than the crossing of downshift thresholds, the vehicle acceleration can be made particularly responsive to sporty accelerator inputs.

Optionally the control system is configured to determine the threshold rate based on a current accelerator input.

Optionally the control system is configured to determine the threshold rate based on a difference between the current accelerator input and a rolling mean of the accelerator input.

Optionally the control system is configured to determine the threshold rate based on the gear ratio currently proposed by the first shift map.

Optionally the threshold rate is higher than another threshold rate which is associated with switching mode away from the first mode when a downshift threshold in the first shift map is crossed.

Optionally the at least two downshift thresholds defined by the common function represent a downshift between two non-adjacent gear ratios which can be performed as a direct shift by automatic transmission hardware.

An advantage of this is that fast shifting is achieved whilst skipping the intervening gear ratios and so the lower gear ratio is achieved sooner and the increased acceleration can be achieved sooner, therefore providing improved responsiveness.

Optionally at least two other downshift thresholds in the second shift map are defined by another common function.

Optionally at least two downshift thresholds defined by the common function in the second shift map have higher values of the speed parameter for a range of accelerator inputs as compared to corresponding downshift thresholds in the first shift map.

Optionally at least some other of the downshift thresholds in the second shift map have higher values of the speed parameter for a range of accelerator inputs as compared to corresponding downshift thresholds in the first shift map.

An advantage of this is that lower gear ratios can be maintained for longer to get maximum mechanical advantage from being in a lower gear ratio in order to provide more responsive vehicle acceleration.

Optionally the at least two downshift thresholds defined by the common function are invariant with accelerator input.

Optionally at least some other of the downshift thresholds in the second shift map are invariant with accelerator input.

An advantage of this is that the triggering of corresponding downshifts may be entirely based on the value of the speed parameter, and can be set to provide the most accelerative gear possible for a range of values of the speed parameter.

According to a further aspect of the invention, there is provided an automatic transmission system comprising the control system.

According to a further aspect of the invention, there is provided a vehicle comprising the automatic transmission system.

According to a further aspect of the invention, there is provided a method of controlling an automatic transmission of a vehicle, the method comprising:
in a first mode, controlling the automatic transmission according to a first shift map which defines downshift thresholds for a speed parameter as functions of accelerator input, wherein each downshift threshold is defined by a unique function;
in a second mode, controlling the automatic transmission according to a second shift map which defines downshift thresholds for the speed parameter as functions of accelerator input, wherein at least two downshift thresholds are defined by a common function;
receiving a signal indicative of a rate of increase in accelerator input; and
switching from the first mode to the second mode, in dependence on the rate of increase in accelerator input exceeding a threshold rate, and regardless of whether a downshift threshold of the first shift map is crossed.

According to a further aspect of the invention there is provided computer readable instructions which, when executed by a computer, are arranged to perform any one or more of the methods described herein. According to a further aspect of the invention there is provided a non-transitory computer readable medium comprising computer readable instructions that, when executed by one or more electronic processors, causes the one or more electronic processors to carry out any one or more of the methods described herein.

Within the scope of this application, it is expressly intended that the various aspects, embodiments, examples and alternatives set out in the preceding paragraphs, in the claims and/or in the following description and drawings, and in particular the individual features thereof, may be taken independently or in any combination that falls within the scope of the appended claims. That is, all embodiments and/or features of any embodiment can be combined in any way and/or combination that falls within the scope of the appended claims, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of a vehicle;

FIG. 2 illustrates an example of at least part of a powertrain of a vehicle;

FIG. 3 illustrates an example of a control system;

FIG. 4 illustrates an example of a non-transitory computer-readable storage medium;

FIG. 5 illustrates an example of a method;

FIGS. 6A and 6B illustrate examples of downshift and upshift thresholds of a shift map;

FIGS. 7A and 7B illustrate examples of downshift and upshift thresholds of another shift map;

FIG. 8 illustrates a further example of the method;

FIG. 9 illustrates examples of downshift thresholds of a shift map;

FIGS. 10A and 10B illustrate examples of downshift and upshift thresholds of another shift map;

FIG. 11 illustrates further examples of the method; and

FIG. 12 illustrates an example of another method.

### DETAILED DESCRIPTION

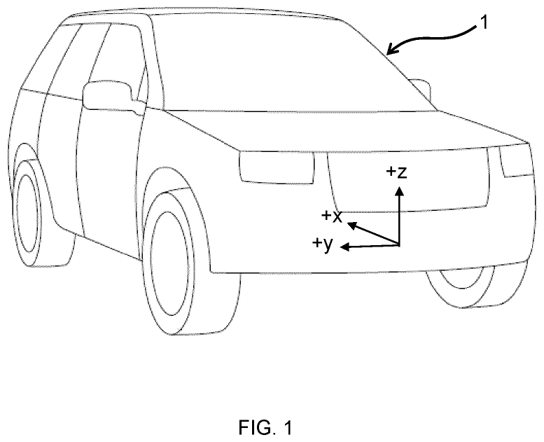

A vehicle 1 in accordance with an embodiment of the present invention is described herein with reference to the accompanying FIG. 1. In some, but not necessarily all examples, the vehicle 1 is a passenger vehicle, also referred to as a passenger car or as an automobile. In other examples, embodiments of the invention can be implemented for other applications, such as commercial vehicles.

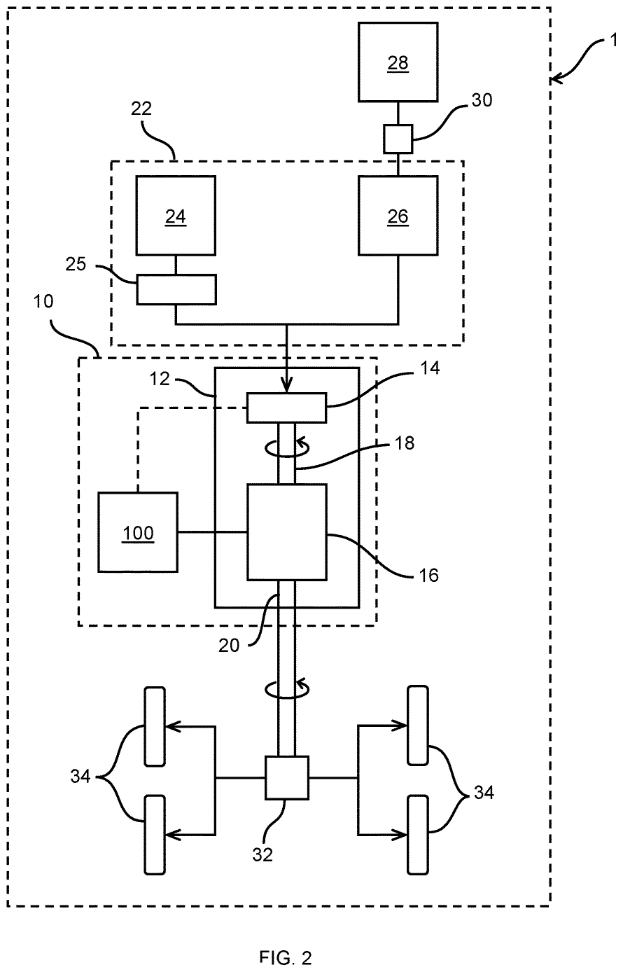

FIG. 2 schematically illustrates an example of at least part of a powertrain of the vehicle 1.

In this example, the vehicle 1 comprises a propulsion system 22 comprising a plurality of torque sources 24, 26 which are selectively operable for the purpose of providing drive torque for accelerating the vehicle 1.

A torque source refers to a prime mover, such as an internal combustion engine, an electric machine such as a traction motor, or the like.

In the illustrated example, the propulsion system 22 comprises two torque sources 24, 26. A first torque source 24 is an internal combustion engine (‘engine’). A second torque source 26 is an electric machine.

The electric machine 26 is an electric motor arranged to convert electrical energy into kinetic energy in the form of mechanical torque and vice versa. The electric motor 26 may be an alternating current induction motor or a permanent magnet motor, or another type of motor. The electric machine 26 is a traction motor configured to enable at least an electric mode comprising electric-only driving. That is, the electric machine 26 can drive the vehicle by itself (without an engine).

This propulsion system 22 is configured to operate in a plurality of predefined operating modes. These include at least an electric mode and a parallel hybrid mode.

In the electric mode (also known as electric vehicle (EV) mode or electric-only mode) the vehicle 1 is propelled only by torque generated by the electric machine 26. The engine 24 may be off (in a non-running state) such that fuel is not combusted, though it may still be rotating if not disconnected from the wheels 34. The engine 24 may alternatively be on but only for the purpose of generating electrical energy and not connected to a torque path to the wheels 34.

In the parallel hybrid mode the vehicle 1 is propelled by torque generated by both the engine 24 and by the electric machine 26.

The predefined operating modes may also include an engine-only mode in which the vehicle 1 is propelled only by torque generated by the engine 24 and there is no electric propulsion.

Transitioning between predefined operating modes of the propulsion system 22 comprises turning on or off one of the torque sources 24, 26 so that, respectively, it either does or does not output torque. In some examples, transitioning between predefined operating modes further comprises mechanically connecting (coupling) or disconnecting (uncoupling) one of the torque sources 24, 26 to the drivetrain. A coupling clutch 25 is provided to mechanically connect and disconnect the engine 24 from the drivetrain. It will be appreciated that the transition between the predefined operating modes is not instantaneous. While the propulsion system 22 is transitioning between predefined operating modes, its mode status is ‘in transition’. The vehicle 1 comprises an automatic transmission system 10 comprising an automatic transmission 12 and a control system 100 such as a transmission control unit/module for controlling the automatic transmission 12.

The automatic transmission 12 comprises a launch device 14 which transfers torque output by the operating torque sources 24, 26 of the propulsion system 22 to the transmission input shaft 18. The launch device 14 may be a fluid coupling such as a torque converter or one or more automatically-actuated friction clutches as found in, for example, a dual-clutch transmission.

The automatic transmission 12 also comprises a gear set and accompanying shifting mechanism, referenced in combination as 16. The gear set 16 comprises a plurality of gears which are selectively couplable into different gear trains to enable multiple gear ratios between the transmission input shaft 18 and the transmission output shaft 20. Each gear may have a corresponding clutch configured to couple them (directly or indirectly) to the transmission output shaft 20.

The clutches and their actuators form the shifting mechanism. The actuators may be solenoids.

The shifting mechanism is controlled to establish a selected gear ratio in accordance with a control signal output by the control system 100. The control system 100 may determine which clutches are involved in shifting to the selected gear ratio and determine how the pressure at the clutches should be controlled to establish the selected gear ratio. The control system 100 may then directly control the actuators associated with these clutches to increase or decrease pressure at these clutches as required.

The control system 100 is also capable of controlling actuation of the launch device 14.

The transmission output shaft 20 is connected to a final set of gears 32, such as a pinion gear meshed with a ring gear, to transfer torque to the wheel axles and thus the vehicle wheels 34.

In order to store electrical energy for the electric machine 26, the vehicle 1 comprises an electrical energy storage means 28. The electrical energy storage means 28 can be a traction battery. The traction battery 28 provides a nominal voltage required by electrical power users such as the electric machine 26.

The traction battery 28 may be a high voltage battery. The traction battery 28 may have a voltage and capacity to support electric only driving for sustained distances. The traction battery 28 may have a capacity of several kilowatt-hours, to maximise range. The capacity may be in the tens of kilowatt-hours, or even over a hundred kilowatt-hours.

Although the traction battery 28 is illustrated as one entity, the function of the traction battery 28 could be implemented using a plurality of small traction batteries in different locations on the vehicle 1.

An inverter 30 converts between the DC output of the traction battery 28 and the AC input required for the electric machine 26.

In view of the above description of the vehicle 1, it will be understood that the vehicle 1 is a full hybrid electric vehicle (HEV). However, in some examples the vehicle 1 may be other than as shown in FIG. 2. The vehicle 1 may be a mild HEV, an internal combustion engine vehicle (ICEV) or otherwise.

Mild HEVs do not have an electric-only mode of propulsion, but the electric machine 26 may be configured to provide assistance such as boosting output torque of the engine 24. The electric machine 26 is not sufficiently powerful to drive the vehicle 1 under electric power alone.

ICEV are propelled solely by an engine 24. Any on-board electric machine is used only as a starter-generator.

At least some of the disclosures made herein can find application in any of these vehicles.

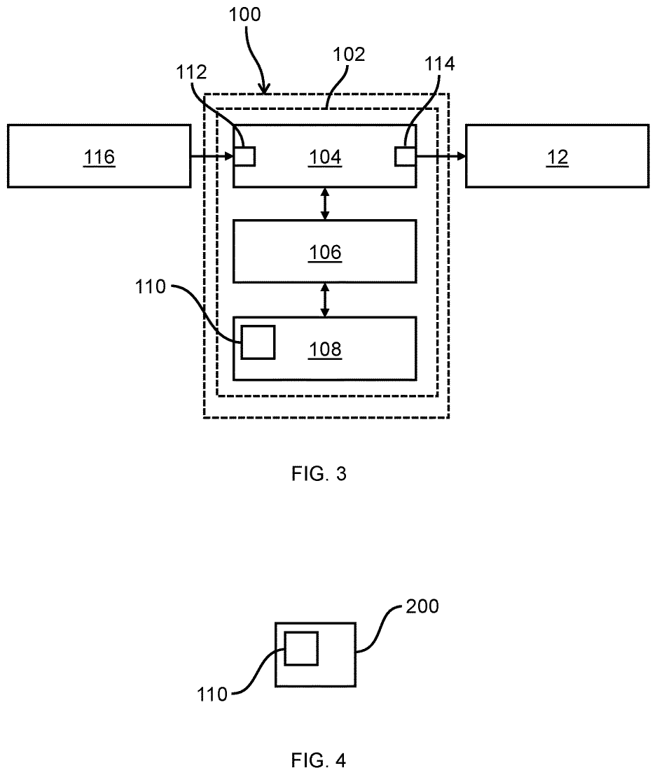

FIG. 3 illustrates an example of the control system 100 for the automatic transmission 12 of the vehicle 1. The control system 100 comprises one or more controllers 102.

The control system 100 is configured to receive data from multiple sensors 116 or other control systems. The control system 100 is configured to receive, from, for example, an accelerator pedal sensor or a system processing the output of the accelerator pedal sensor to determine a torque to request of the propulsion system 22 or from an automated driving system (ADS) or an advanced driver-assistance system (ADAS), data about a rate of increase in accelerator input or accelerator input data from which the control system 100 can determine a rate of increase in accelerator input. The control system 100 may also be configured to receive speed parameter data from, for example, a crank position sensor, a drivetrain speed sensor, a wheel speed sensor measure, or the like. The control system 100 may also be configured to receive data about a current road load or data from which the current road load can be calculated such as estimated vehicle mass, estimated slope (road gradient), estimated aerodynamic resistance, and/or estimated rolling resistance.

The control system 100 is configured to determine when to switch a mode of controlling the automatic transmission 12 so that an active shift map is changed. The control system is configured to switch mode accordingly.

The control system 100 is configured to control the automatic transmission 12 according to the active shift map by determining a destination gear ratio using the active shift map and by, for example, outputting a control signal comprising instructions to cause initiation of a shift to the destination gear ratio (by for example controlling hardware of the automatic transmission 12, and specifically the shifting mechanism which functions to establish a gear ratio).

The control system 100 as illustrated in FIG. 3 comprises one controller 102, although it will be appreciated that this is merely illustrative. The controller 102 comprises processing means 106 and memory means 108. The processing means 106 may be one or more electronic processing devices 106 which operably execute computer-readable instructions. The memory means 108 may be one or more memory devices 108. The memory means 108 is electrically coupled to the processing means 106. The memory means 108 is configured to store instructions, and the processing means 106 is configured to access the memory means 108 and execute the instructions stored thereon.

The controller 102 comprises an input means 112 and an output means 114. The input means 112 may comprise an electrical input 112 of the controller 102. The output means 114 may comprise an electrical output 114 of the controller 102. The controller 102 may have an interface 104 comprising an electrical input/output I/O 112, 114, or an electrical input 112, or an electrical output 114, for receiving information and interacting with external components. The input 112 is arranged to receive a plurality of signal from a plurality of sensors 116 or other control systems. At least one signal is an electrical signal which is indicative of a rate of increase in accelerator input. Other received signals may include an electrical signal which is indicative of a speed parameter and one or more electrical signals which are indicative of a road load. The output 114 is arranged to output control signals comprising instructions to cause initiation of a gear shift.

FIG. 4 illustrates a non-transitory computer-readable storage medium 200 comprising the instructions (computer software).

It is to be understood that the, or each, controller 102 can comprise a control unit or computational device having one or more electronic processors (e.g., a microprocessor, a microcontroller, an application specific integrated circuit (ASIC), etc.), and may comprise a single control unit or computational device, or alternatively different functions of the or each controller 102 may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the controller 102 to implement the control techniques described herein (including some or all of the functionality required for the method(s) described herein). The set of instructions 110 could be embedded in said one or more electronic processors 106 of the controller 102; or alternatively, the set of instructions 110 could be provided as software to be executed in the controller 102. A first controller or control unit may be implemented in software run on one or more processors. One or more other controllers or control units may be implemented in software run on one or more processors, optionally the same one or more processors as the first controller or control unit. Other arrangements are also useful.

The, or each, electronic processor 106 may comprise any suitable electronic processor (e.g., a microprocessor, a microcontroller, an ASIC, etc.) that is configured to execute electronic instructions 110. The, or each, electronic memory device 108 may comprise any suitable memory device and may store a variety of data, information, threshold value(s), lookup tables or other data structures, and/or instructions therein or thereon. In an embodiment, the memory device 108 has information and instructions for software, firmware, programs, algorithms, scripts, applications, etc. stored therein or thereon that may govern all or part of the methodology described herein. The processor, or each, electronic processor 106 may access the memory device 108 and execute and/or use that or those instructions and information to carry out or perform some or all of the functionality and methodology described herein.

The at least one memory device 108 may comprise a computer-readable storage medium (e.g. a non-transitory or non-transient storage medium) that may comprise any mechanism for storing information in a form readable by a machine or electronic processors/computational devices. Examples of the form include, without limitation: a read only memory (ROM); random access memory (RAM); erasable programmable memory (e.g. EPROM ad EEPROM); flash memory; or electrical or other types of medium for storing such information/instructions.

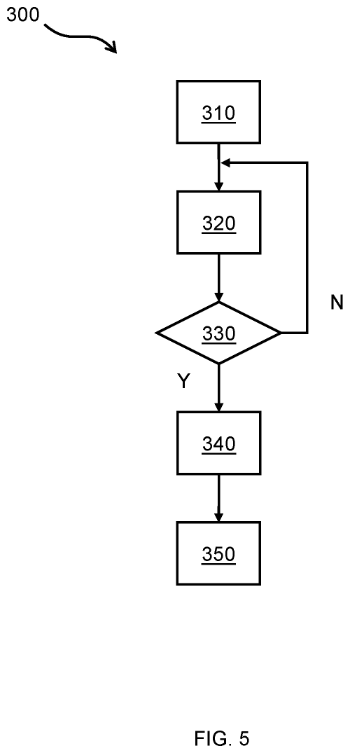

FIG. 5 illustrates an example of a method 300 of controlling the automatic transmission 12 of the vehicle 1. The method 300 may be performed by the control system 100 illustrated in FIG. 3. In particular, the memory 108 may comprise computer-readable instructions 110 which, when executed by the processor 106, perform the method 300.

The method 300 relates to entry into a mode of controlling the automatic transmission 12 in which its response times to rapid increases in accelerator input are improved.

Automatic transmissions are controlled according to whichever shift map is active at a given time.

Shift maps are used to determine a destination gear ratio for the automatic transmission 12 based on a speed parameter and an accelerator input. The speed parameter may be any speed parameter suitable for enabling a determination of a gear ratio in which to place the automatic transmission 12.

For example, the speed parameter may be a speed parameter of the vehicle 1, such as its longitudinal speed (a longitudinal direction being defined by an axis between the front and rear of the vehicle 1). Alternatively, the speed parameter may be a speed parameter of a powertrain component, such as a rotational speed of one or more of the wheels 34, or of a transmission output shaft 20, or of a transmission input shaft 18 (which may be measured from a rotational speed of a turbine of the torque converter 14), or of the engine 24 and/or electric machine 26. In some examples, the speed parameter may be a ratio between foregoing parameters, particularly between those pertaining to speeds on either side of the gearset 16, such as a ratio between the vehicle's longitudinal speed and the engine/electric machine speed or a ratio between the wheel speed and the transmission input shaft speed.

In some examples the speed of the transmission output shaft 20 may be used because it may be measured within the automatic transmission system 10 and accordingly network latency and communication issues do not affect the signal which is indicative of it.

The accelerator input may be dependent on for example, accelerator pedal depression (APD) or autonomous driving torque demand from an automated driving system (ADS) or an advanced driver-assistance system (ADAS). The accelerator input may be indicative of a torque requested or to be requested of the propulsion system 22.

Shift maps define a plurality of regions of a parameter space which is spanned by the speed parameter and the accelerator input.

Each of the regions of the parameter space defined by a shift map is associated with a different gear ratio. The highest gear ratio provides the fastest transmission output speed for a given transmission input speed. The lowest gear ratio provides the slowest transmission output speed for a given transmission input speed. Upshifting increases the gear ratio whilst downshifting decreases the gear ratio.

A region associated with the highest gear ratio comprises a lower speed parameter boundary (downshift threshold) as a function of the accelerator input.

A region associated with the lowest gear ratio comprises an upper speed parameter boundary (upshift threshold) as a function of the accelerator input.

Each region associated with intervening gear ratios comprises a lower speed parameter boundary (downshift threshold) as a function of the accelerator input and an upper speed parameter boundary (upshift threshold) as a function of the accelerator input.

The functions which define the gear shift (ratio change) thresholds can be specified in various forms. For example, each of the functions could be specified by a mathematical formula or mathematical formulas (for example in the case of a piecewise function). Alternatively, each of the functions could be specified by listing values of the function, for example in a table or array. The table or array can give the values of the function at specific values of the accelerator input. If a value of the function associated with an intermediate value of the accelerator input is needed, interpolation can be used to estimate the value of the function. The values of the function at specific values of the accelerator input are known as “shift points”. Shift points associated with a downshift are known as “downshift points”. Shift points associated with an upshift are known as “upshift points”.

A gear ratio which is different to the current gear ratio may be proposed by a shift map when a current value of the accelerator input and a current value of the speed parameter describe a point within the defined parameter space which is not within the region associated with the current gear ratio. The proposed gear ratio is the one associated with the region in which the point lies.

For each gear ratio, the region associated with this gear ratio may at least partially overlap with the regions for its nearest neighbouring gear ratios (by size).

If the point described by a current value of the accelerator input and a current value of the speed parameter lies within an overlap between two or more regions, then the ratio proposed will depend on the direction of entry into the region.

Controlling the automatic transmission 12 according to an active shift map comprises shifting from a current gear ratio to a destination gear ratio which is based on the gear ratio proposed by the active shift map. This may be accomplished by receiving inputs indicative of speed parameter and accelerator input and by outputting a control signal comprising instructions to cause initiation of a gear shift, for example by controlling hardware of the automatic transmission 12, specifically the shifting mechanism which functions to establish a gear ratio.

It will be appreciated however that a gear ratio proposed by the active shift map may be further subjected to restrictions on gear availability before the destination gear ratio is determined in final arbitration. For example, the number of gear ratios which may be skipped over in shifting from the current gear ratio to a destination gear ratio may be limited.

A gear ratio proposed by the active shift map may also be further subjected to gear shift inhibit conditions before the destination gear ratio is determined in final arbitration. Examples of shift inhibit conditions include, without limitation:

being within a defined period of time from completion of a previous shift; advanced driver-assistance systems (ADAS) features such as adaptive cruise control being active; being engaged in downhill driving, or at least downhill driving above a threshold gradient; a rate of decrease in the accelerator input exceeding a threshold rate; being engaged in cornering, or at least cornering exceeding a threshold based on a lateral acceleration;

being engaged in reversing; a propulsion system of the vehicle being in transition between predefined operating modes; a different target gear ratio being determined based on a change to at least one of: the speed parameter, the accelerator input, or the active shift map; and a rate of decrease in a powertrain torque exceeding a threshold rate.

Returning to the method 300 specifically, the control of the automatic transmission 12 begins in a first mode at block 310. The first mode may be a mode used in normal driving.

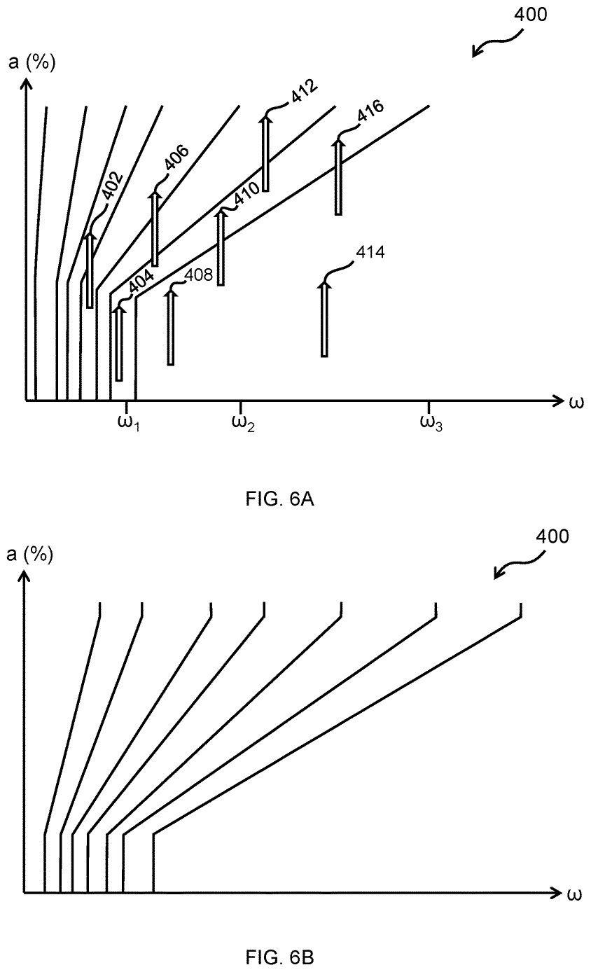

In the first mode, the automatic transmission 12 is controlled according to a first shift map 400, an example of which is illustrated in FIGS. 6A and 6B. The first shift map 400 is the active shift map in the first mode.

Each of the lower speed parameter boundaries (downshift thresholds) in the first shift map 400 is unique. The first shift map 400 defines a unique set of downshift points for each downshift. In some examples, none of the lower speed parameter boundaries (downshift thresholds) overlap or intersect with one another. None of the sets share any downshift points. The downshift points may be calibrated such that a downshift will be proposed as the powertrain reaches the maximum possible torque for a given value of the speed parameter.

It may also be the case that none of the upper speed parameter boundaries (upshift thresholds) in the first shift map 400 overlap or intersect with one another. None of the sets share any upshift points.

Different first shift maps may be active at different times during operation in the first mode, depending on current operating conditions. In the first mode, therefore, the gear shift thresholds may vary with changing operating conditions.

The first shift map 400 which is active at a given time during operation in the first mode can be obtained from a set of first shift maps stored in the memory 108 of the control system 100. The set of first shift maps stored in the memory 108 cover a finite, discrete set of specific operating conditions, concerning both internal and external factors. If current operating conditions do not match these, then interpolation between stored first shift maps 8 associated with operating conditions which are similar but different to the current operating conditions may be performed to generate a first shift map tailored to the current operating conditions. Other, non-interpolative modifications to the gear shift thresholds may be additionally or alternatively applied to account for the current operating conditions.

The first shift map 400 which is active at a given time during operation in the first mode may be based on the current road load. Road load is a reflection of driving resistance calculated from weight, slope, or the like. Road load may be calculated from one or more estimated vehicle mass, estimated slope (road gradient), estimated aerodynamic resistance, and estimated rolling resistance, which may each be indicated by signals received by the control system 100. Alternatively, road load may be indicated directly by a signal received by the control system 100.

Different ones of the set of first shift maps stored in the memory 108 can be associated with different road loads. Different ones of these first shift maps can be selected and used when working against different road loads. Different ones of these first shift maps may be specifically calibrated to compensate for a different road load, typically adopting a more aggressive profile where gear shifts are triggered at higher values of the speed parameter for higher road loads.

If one from the set of first shift maps is associated with the current road load, it can be selected as the active shift map. If not, then the active shift map may be obtained by interpolation between at least two from the set of first shift maps associated with similar road loads to the current road load, for example a pair of first shift maps associated with a road load interval in which the current road load resides.

The first shift map 400 which is active at a given time during operation in the first mode may be obtained from the set of first shift maps with further dependence on one or more other current operating conditions in addition to the current road load such as: air pressure (accounting for both altitude and temperature), driving style of the driver, operating mode of the propulsion system 22, or reduction in powertrain capability (if any).

Block 320 of the method 300 comprises receiving a signal indicative of a rate of increase in accelerator input.

The signal may be an accelerator input gradient (rate of change) signal or may be a sequence of accelerator input signals from which the rate of change can be determined by their change over time.

Block 330 of the method 300 comprises determining whether the rate of increase in accelerator input exceeds a threshold rate.

If the rate of increase in accelerator input exceeds the threshold rate (‘Y’ path from block 330), the method 300 advances to block 340. Block 340 comprises switching from the first mode to a second mode of controlling the automatic transmission 12.

The rate of increase in accelerator input exceeding the threshold rate may be the sole requirement for triggering a switch from the first mode to the second mode. There is no requirement for a downshift threshold of the first shift map 400 to be crossed in order to trigger a switch from the first mode to the second mode.

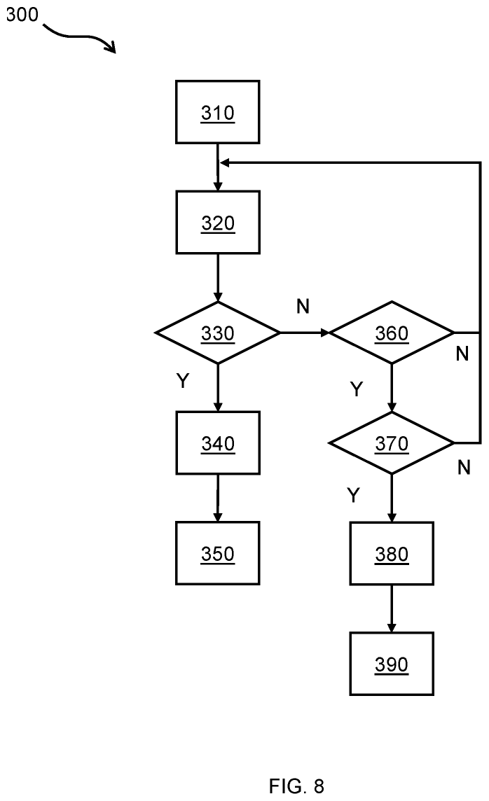

If the rate of increase in accelerator input does not exceed the threshold rate (‘N’ path from block 330), there is no entry into the second mode. In some examples, the operation in the first mode continues. In other examples, operation in the first mode may continue or a switch to a third mode may be made if the rate of increase in accelerator input exceeds another, lower threshold rate. The third mode and the another, lower threshold rate are described further in relation to FIG. 8.

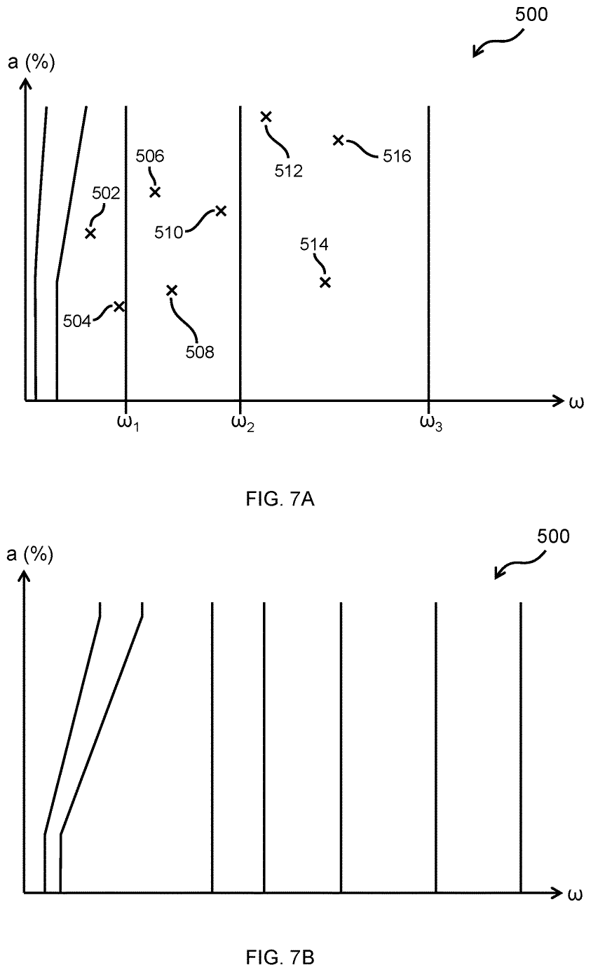

In the second mode, the automatic transmission 12 is controlled according to a second shift map 500, an example of which is illustrated in FIGS. 7A and 7B. The second shift map 500 is the active shift map in the second mode.

Following the mode switch at block 340, block 350 therefore comprises controlling the automatic transmission 12 according to the second shift map 500. The mode switch therefore comprises changing the active shift map. The active shift map is not, however, changed while operating in the second mode. The automatic transmission 12 is controlled according to the same second shift map 500 until the second mode is exited.

At least some of the lower speed parameter boundaries (downshift thresholds) in the second shift map 500 are shared. At least two downshift thresholds are defined by a common function. The second shift map 500 may therefore define at least two downshifts according to a shared set of downshift points. In some examples at least two other downshift thresholds are defined by another common function. The second shift map 500 may therefore define at least two other downshifts according to another shared set of downshift points.

The downshift thresholds of the second shift map 500 may be invariant with changing road loads. The second mode may not involve using different second shift maps, which are calibrated to compensate for different road loads, based on the current road load. Accordingly, during operation in the second mode, the downshift thresholds are invariant with changing road load.

In contrast to the lower speed parameter boundaries (downshift thresholds), each of the upper speed parameter boundaries (upshift thresholds) in the second shift map 500 may be unique. The second shift map 500 may define a unique set of upshift points for each upshift. In some examples, none of the upper speed parameter boundaries (upshift thresholds) overlap or intersect with one another. None of the sets share any upshift points. In other examples, at least some of the upper speed parameter boundaries (upshift thresholds) may coincide with one another for a range of accelerator inputs. Upshift points may, for example, be shared between at least two upshifts at low accelerator inputs. Upshift points associated with these at least two upshifts diverge at higher accelerator inputs.

FIG. 6A illustrates an example of downshift thresholds of the first shift map 400. The speed parameter, w, is shown on the x-axis with respect to accelerator input, a, on the y-axis. In this example the first shift map 400 is for an eight-speed transmission and accordingly seven downshift thresholds are shown. The right-most of these lines represents the downshift threshold for triggering a downshift out of the eighth gear (highest gear ratio) and the left-most of the lines represents the downshift threshold for triggering a downshift into the first gear (lowest gear ratio). Intervening lines successively represent downshift thresholds for triggering downshifts from the seventh gear through to the second gear.

FIG. 6B illustrates an example of upshift thresholds of the same first shift map 400. The speed parameter, ω, is shown on the x-axis with respect to accelerator input, a, on the y-axis. Seven upshifts thresholds are shown. The left-most of these lines represents the upshift threshold for triggering an upshift out of the first gear (lowest gear ratio) and the right-most of these lines represents the upshift threshold for triggering an upshift into the eighth gear (highest gear ratio). Intervening lines successively represent upshift thresholds for triggering upshifts from the second gear through to the seventh gear.

Focussing on FIG. 6A, a number of rapid increases in accelerator input are shown for different starting value of the accelerator input and for different values of the speed parameter at the time of the increase. These are illustrated as vertical arrows 402-416 within the plot of the parameter space. They are each the same length, representing the same magnitude of increase in a given time, in other words, the same rate of increase. This rate of increase exceeds the threshold rate and thus triggers the switch from the first mode in which the first shift map 400 is active to the second mode in which the second shift map 500 is active.

The points within the parameter space described by the beginning and end of the arrows 402-416 represent the gear ratios which are, or would be, proposed by the first shift map 400 before and after the increase in accelerator input. These may, subject to other restrictions, therefore represent the current gear ratio and the destination gear ratio when the automatic transmission 12 is controlled according to the first shift map 400.

Arrow 402 crosses one downshift threshold and represents a proposed shift from a fifth gear into a fourth gear according to the first shift map 400. Arrow 404 does not cross any downshift thresholds and thus represents no proposed shift from seventh gear. Arrow 406 crosses two downshift thresholds and represents a shift from seventh gear into fifth gear. Arrow 408 does not cross any downshift thresholds and thus represents no proposed shift from eighth gear. Arrow 410 crosses one downshift threshold and represents a shift from eighth gear to seventh gear. Arrow 412 crosses one downshift threshold and represents a shift from seventh gear to sixth gear. Arrow 414 does not cross any downshift thresholds and thus represents no proposed shift from eighth gear. Arrow 416 crosses one downshift threshold and represents a shift from eighth gear to seventh gear. Multiple downshifts may be expected in rapid response to any one of the rapid increases in accelerator input represented by arrows 402-416. However, if the magnitude of the increase is not enough to cross multiple downshift thresholds then multiple downshifts will only follow if the accelerator input continues to be increased, crossing subsequent downshift thresholds. This can lead to a slower set of downshifts through a sequence of adjacent (by size) gear ratios, rather than a single direct downshift between non-adjacent gear ratios. This can give the impression of a lack of responsiveness to accelerator input.

FIG. 7A illustrates an example of downshift thresholds of the second shift map 500. The speed parameter, ω, is shown on the x-axis with respect to accelerator input, a, on the y-axis. In this example the second shift map 500 is for the same eight-speed transmission as the first shift map 400 illustrated in FIGS. 6A and 6B. In the second shift map 500, however, only five distinct downshift thresholds can be seen. This is because two of the downshift thresholds are defined by a common function and another two of the downshift thresholds are defined by another common function.

The right-most of these lines represents both the downshift threshold for triggering a downshift out of the eighth gear into the seventh gear and the downshift threshold for triggering a downshift out of the seventh gear into the sixth gear, yielding an effective downshift threshold for triggering a downshift out of the eighth gear into the sixth gear. This effective downshift threshold is associated with a gear skip over the seventh gear. Accordingly, crossing this effective downshift threshold can trigger a downshift from the eighth gear to the sixth gear, skipping over the seventh gear. The next line to the left represents both the downshift threshold for triggering a downshift out of the sixth gear into the fifth gear and the downshift threshold for triggering a downshift out of the fifth gear into the fourth gear, yielding an effective downshift threshold for triggering a downshift out of the sixth gear into the fourth gear. This effective downshift threshold is associated with a gear skip over the fifth gear. Accordingly, crossing this effective downshift threshold can trigger a downshift from the sixth gear to the fourth gear, skipping over the fifth gear.

The next line again to the left represents the downshift threshold for triggering a downshift out of the fourth gear into the third gear.

These downshift thresholds, associated with downshifts out of the eighth gear through to the third gear, are all defined by different respective functions to corresponding downshift thresholds in the first shift map 400.

The two left-most lines represent the downshifts into the second and first gears respectively. In some examples these are defined by the same functions as respectively defined corresponding downshift thresholds in the first shift map 400.

A number of x-shaped markers 502-516 respectively represent the points within the parameter space described by the end of the arrows 402-416 illustrated in FIG. 6A. Since the rate of increase in accelerator input represented by the arrows 402-416 exceeds the threshold rate, in accordance with the method 300, the active shift map is changed from the first shift map 400 to the second shift map 500 as a result of these increases and it is the gear ratio associated with the region of the second shift map 500 in which the described point lies upon which the destination gear is based.

Marker 502 lies within the region associated with the third gear in the second shift map 500. In response to the increase represented by arrow 402 therefore, the proposed shift is from the fifth gear to the third gear. The method 300 therefore achieves a benefit of an additional step in the gear ratio change as compared with conventional control according to only the first shift map 400.

Marker 504 lies within the region associated with the third gear. In response to the increase represented by arrow 404 therefore, the proposed shift is from the seventh gear to the third gear. The method 300 therefore achieves a benefit of four additional steps in the gear ratio change as compared with conventional control according to only the first shift map 400 and according to which no shift is proposed.

Marker 506 lies within the region associated with fourth gear. In response to the increase represented by arrow 406 therefore, the proposed shift is from the seventh gear to the fourth gear. The method 300 therefore achieves a benefit of an additional step in the gear ratio change as compared with conventional control according to only the first shift map 400.

Marker 508 lies within the region associated with fourth gear. In response to the increase represented by arrow 408 therefore, the proposed shift is from the eighth gear to the fourth gear. The method 300 therefore achieves a benefit of four additional steps in the gear ratio change as compared with conventional control according to only the first shift map 400 and according to which no shift is proposed.

Marker 510 lies within the region associated with fourth gear. In response to the increase represented by arrow 410 therefore, the proposed shift is from the eighth gear to the fourth gear. The method 300 therefore achieves a benefit of three additional steps in the gear ratio change as compared with conventional control according to only the first shift map 400.

Marker 512 lies within the region associated with sixth gear. In response to the increase represented by arrow 412 therefore, the proposed shift is from the seventh gear to the sixth gear. In this instance, the method 300 does not achieve an immediate benefit upon switching (block 340) as compared with conventional control according to only the first shift map 400, however, benefits will arise from continuing control of the automatic transmission 12 according to the second shift map 500 (block 350).

Marker 514 lies within the region associated with sixth gear. In response to the increase represented by arrow 414 therefore, the proposed shift is from the eighth gear to the sixth gear. The method 300 therefore achieves a benefit of two additional steps in the gear ratio change as compared with conventional control according to only the first shift map 400 and according to which no shift is proposed.

Marker 516 within the region associated with sixth gear. In response to the increase represented by arrow 416 therefore, the proposed shift is from the eighth gear to the sixth gear. The method 300 therefore achieves a benefit of an additional step in the gear ratio change as compared with conventional control according to only the first shift map 400.

Switching the active map from the first shift map 400 to the second shift map 500 (block 340) can therefore result in the proposal of a gear ratio change to lower gear ratios of one or more steps despite no downshift thresholds having been crossed or despite less downshift thresholds having been crossed than the step change. It will be observed that this benefit, in terms of steps gained, is particularly great when the starting value of the accelerator input is low because, in the first shift map 400, there are few possibilities to cross downshift thresholds without the change in speed which is responsive to, but lags, the increased accelerator input except when the starting value of the accelerator input is already high.

In some examples, at least some of the downshift thresholds in the second shift map 500 have higher values of the speed parameter for a range of accelerator inputs, as compared to corresponding downshift thresholds in the first shift map 400. This may be true of the at least two downshift thresholds defined by the common function in the second shift map 500. This may also be true of the at least other two downshift thresholds defined by the another common function in the second shift map 500.

Of the at least two downshift thresholds defined by the common function, the one which is associated with triggering a downshift into the lowest gear ratio (of the gear ratios associated with the common function, not necessarily the absolute lowest gear ratio available in the automatic transmission 12) may have higher values of the speed parameter for all accelerator inputs as compared to the corresponding downshift threshold in the first shift map 400. In the example of FIG. 7A, the one which is associated with triggering a downshift into the lowest gear ratio (of the gear ratios associated with the common function) refers to the downshift threshold into the sixth gear.

In some examples, of the at least two downshift thresholds defined by the common function, the one which is associated with triggering a downshift out of the highest gear ratio (of the gear ratios associated with the common function) may have higher values of the speed parameter for all accelerator inputs as compared to the corresponding downshift threshold in the first shift map 400. In other examples (and as illustrated), the one which is associated with triggering a downshift out of the highest gear ratio (of the gear ratios associated with the common function) may have the same 12 maximum value (ω₃) of the speed parameter at which the downshift can be triggered as the corresponding downshift threshold in the first shift map 400; however, it may have higher values of the speed parameter for all accelerator inputs at which the corresponding downshift threshold in the first shift map 400 is less than this maximum value. In the example of FIG. 7A, the one which is associated with triggering a downshift out of the highest gear ratio (of the gear ratios associated with the common function) refers to the downshift threshold out of the eighth gear.

Likewise, of the at least two downshift thresholds defined by the another common function, the one which is associated with triggering a downshift into the lowest gear ratio (of the gear ratios associated with the another common function, not necessarily the absolute lowest gear ratio available in the automatic transmission 12) may have higher values of the speed parameter for all accelerator inputs as compared to the corresponding downshift thresholds in the first shift map 400. In the example of FIG. 7A, the one which is associated with triggering a downshift into the lowest gear ratio (of the gear ratios associated with the another common function) refers to the downshift threshold into the fourth gear.

In some examples, of the at least two downshift thresholds defined by the another common function, the one which is associated with triggering a downshift out of the highest gear ratio (of the gear ratios associated with the common function) may have higher values of the speed parameter for all accelerator inputs as compared to the corresponding downshift threshold in the first shift map 400. In other examples (and as illustrated), the one which is associated with triggering a downshift out of the highest gear ratio (of the gear ratios associated with the another common function) may have the same maximum value (ω₂) of the speed parameter at which the downshift can be triggered as the corresponding downshift threshold in the first shift map 400; however, it may have higher values of the speed parameter for all accelerator inputs at which the corresponding downshift threshold in the first shift map 400 is less than this maximum value. In the example of FIG. 7A, the one which is associated with triggering a downshift out of the highest gear ratio (of the gear ratios associated with the another common function) refers to the downshift threshold out of the sixth gear.

Accordingly, during control of the automatic transmission 12 according to the second shift map 500 (block 350) the sixth gear and the fourth gear can be adopted at higher values of the speed parameter than under control according to the first shift map 400. Their mechanical advantages over the higher gear ratios that would be adopted at equivalent speeds under control according to the first shift map 400 result in more responsive acceleration of the vehicle 1.

In the example of FIG. 7A, the downshift threshold representing a downshift from the fourth gear into the third gear also has the same maximum value (ω₁) of the speed parameter at which the downshift can be triggered as the corresponding downshift threshold in the first shift map 400; however, it has higher values of the speed parameter for all accelerator inputs at which the corresponding downshift threshold in the first shift map 400 is less than this maximum value. In other examples, this downshift threshold in the second shift map 500 may have higher values of the speed parameter for all accelerator inputs as compared to corresponding downshift thresholds in the first shift map 400. In either case, the third gear can accordingly be adopted with less accelerator input at a given speed.

In some examples, at least some of the downshift thresholds in the second shift map 500 are invariant with accelerator input, or are invariant with accelerator input at least where the accelerator input is below a maximum value of the accelerator input achievable without kickdown (not shown) in the case of input derived from accelerator pedal depression. This may be true of the at least two downshift thresholds defined by the common function in the second shift map 500. This may also be true of the at least other two downshift thresholds defined by the another common function in the second shift map 500. In the example of FIG. 7A, this is true of the two downshift thresholds representing a downshift from the eighth gear into the sixth gear, the two downshift thresholds representing a downshift from the sixth gear into the fourth gear, and the downshift threshold representing a downshift from the fourth gear into the third gear.

Therefore, during control of the automatic transmission 12 according to the second shift map 500 (block 350), a downshift from the eighth gear into the sixth gear is triggered at the same value of the speed parameter (ω₃) regardless of the accelerator input. The triggering of this downshift is entirely based on the value of the speed parameter.

Likewise, a downshift from the sixth gear into the fourth gear is triggered at the same value of the speed parameter (ω₂) regardless of the accelerator input. The triggering of this downshift is entirely based on the value of the speed parameter.

Further likewise, a downshift from the fourth gear into the third gear is triggered at the same value of the speed parameter (ω₁) regardless of the accelerator input. The triggering of this downshift is entirely based on the value of the speed parameter.

It will also therefore be observed that during initial control of the automatic transmission 12 according to the first shift map 400 (block 310) any increase in accelerator input which is sufficiently rapid to trigger the mode switch (block 340) while the value of the speed parameter is between ω₂ and ω₃ will cause the sixth gear to be proposed for the destination gear ratio. The sixth gear is the lowest gear ratio suitable for speeds in the ω₂ to ω₃ range. Likewise, any sufficiently rapid increase in accelerator input while the value of the speed parameter is between ω₁ and ω₂ will cause the fourth gear to be proposed for the destination gear ratio. The fourth gear is the lowest gear ratio suitable for speeds in the ω₁ to ω₂ range.

In the example of FIG. 7A, two of the downshift thresholds which are defined by the common function are those associated with triggering a downshift from eighth to seventh gear and with triggering a downshift from seventh to sixth gear. These are chosen because the downshift from eighth to sixth gear is one which can be performed as a direct shift by the hardware of the automatic transmission 12 in this example. Likewise, the downshift from sixth to fourth gear is one which can be performed as a direct shift by the hardware of the automatic transmission 12 in this example. In other examples, the hardware limitations of the automatic transmission 12 may differ and different downshifts may be performable as direct shifts. It will therefore be appreciated that, in respect of any given automatic transmission 12, the at least two downshift thresholds which are defined by the common function may represent a downshift between two non-adjacent (by size) gear ratios which can be performed as a direct shift by the automatic transmission hardware. A direct gear shift differs from interlocking or staged gear shifts in that none of the intervening gear ratios are connected into the torque path to the wheels 34 during the shift from a current gear ratio to a destination gear ratio.

FIG. 7B illustrates an example of upshift thresholds of the same second shift map 500. The speed parameter, ω, is shown on the x-axis with respect to accelerator input, a, on the y-axis. Seven upshift thresholds are shown. The left-most of these lines represents the upshift threshold for triggering an upshift out of the first gear (lowest gear ratio) and the right-most of these lines represents the upshift threshold for triggering an upshift into the eighth gear (highest gear ratio). Intervening lines successively represent upshift thresholds for triggering upshifts from the second gear through to the seventh gear.

At least some of the upshift thresholds are invariant with accelerator input, or are invariant with accelerator input at least where the accelerator input is below a maximum value of the accelerator input achievable without kickdown (not shown) in the case of input derived from accelerator pedal depression. These upshift thresholds may be defined so as to trigger upshifts entirely based on the value of the speed parameter. The values of the speed parameter at which these upshifts are triggered are the maximum values (in some examples with kickdown and in some examples without kickdown) at which corresponding upshifts can be triggered according to the first shift map 400.

In this example, each of the upshift thresholds for triggering upshifts from the third gear through to the eighth gear is invariant with accelerator input. The upshift thresholds for triggering upshifts from the first and second gears are functions of the accelerator input and are defined by the same functions as define corresponding upshift thresholds in the first shift map 400.

In the foregoing, it has been assumed that the first shift map 400 is the one from the set of first shift maps which has the highest residency during normal driving. That is, it is the one which is the most often active during normal driving. In the case that it is not, all aspects of the second shift map 500 which have been described or defined in relation to the first shift map 400 may additionally or alternatively be understood as being described or defined in relation to the one from the set of first shift maps which does have the highest residency during normal driving.

FIG. 8 Illustrates a Further Example of the Method 300.

Blocks 310-350 are as described in relation to FIG. 5.

In this further example, if the rate of increase in accelerator input does not exceed the threshold rate (‘N’ path from block 330), the method 300 advances to block 360. Block 360 comprises determining whether the rate of increase in accelerator input exceeds another, lower threshold rate.

If the rate of increase in accelerator input exceeds the another, lower threshold rate (‘Y’ path from block 360), the method 300 advances to block 370. Block 370 comprises determining whether a downshift threshold of the first shift map 400, which is currently the active shift map, is crossed.

If a downshift threshold of the first shift map 400 is crossed (‘Y’ path from block 370), the method 300 advances to block 380. Block 380 comprises switching from the first mode to a third mode of controlling the automatic transmission 12.

In some examples, the switching (block 380) is dependent on a downshift threshold of the first shift map 400 being crossed while the rate of increase in accelerator input remains in excess of the another, lower threshold rate or being crossed within a predefined period following the final determination of the rate of increase in accelerator input being in excess of the another, lower threshold rate.

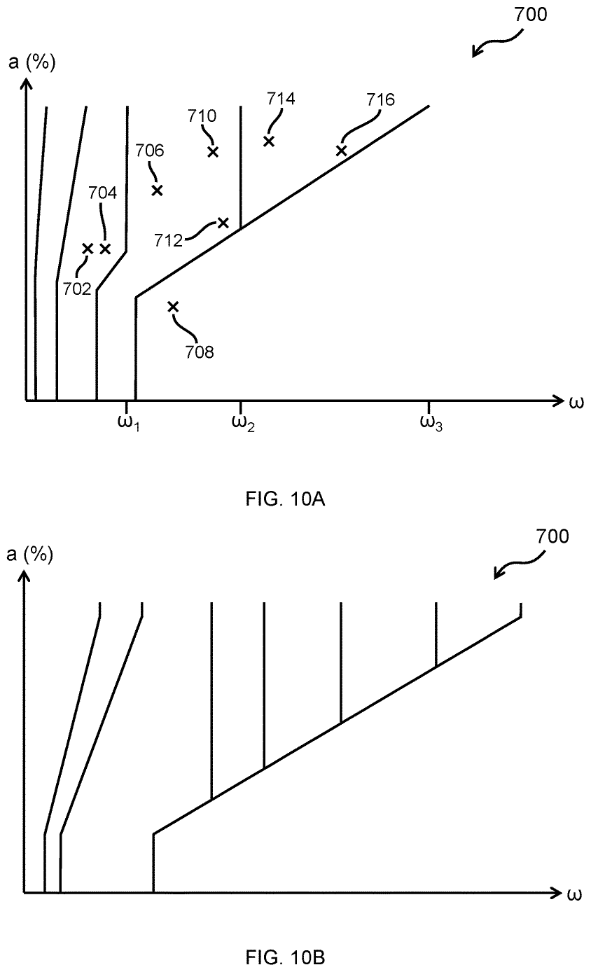

In the third mode, the automatic transmission 12 is controlled according to a third shift map 700, an example of which is illustrated in FIGS. 10A and 10B. The third shift map 700 is the active shift map in the third mode.

Following the mode switch at block 380, block 390 therefore comprises controlling the automatic transmission 12 according to the third shift map 700. The mode switch therefore comprises changing the active shift map. The active shift map is not, however, changed while operating in the third mode. The automatic transmission 12 is controlled according to the same third shift map 700 until the third mode is exited. Accordingly, the third mode does not involve using different third shift maps, which are calibrated to compensate for different road loads, based on the current road load. During operation in the third mode, the downshift thresholds are therefore invariant with changing road load.

If the rate of increase in accelerator input does not exceed the another, lower threshold rate or if no downshift threshold of the first shift map 400 is crossed, then there is no entry into the second mode. In some examples, the operation in the first mode continues.

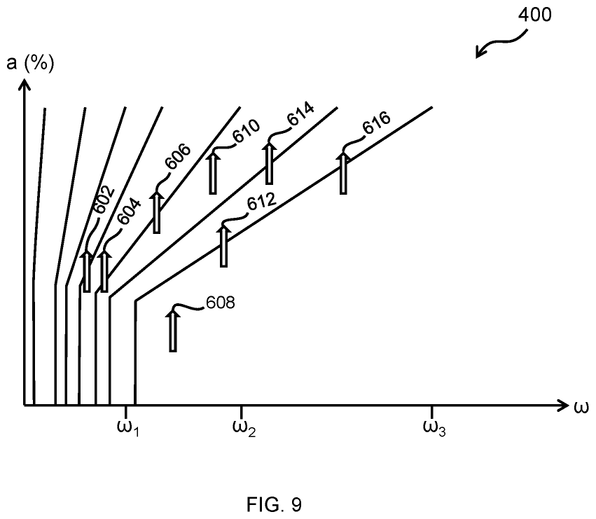

FIG. 9 illustrates the same example of downshift thresholds of the first shift map 400 as shown in FIG. 6A.

A number of increases in accelerator input are shown for different starting value of the accelerator input and for different values of the speed parameter at the time of the increase. These are illustrated as vertical arrows 602-616 within the plot of the parameter space. They are each the same length, representing the same magnitude of increase in a given time, in other words, the same rate of increase. This rate of increase is less than the threshold rate against which the rate of increase in accelerator input is compared at block 330 but exceeds the another, lower threshold rate against which the rate of increase in accelerator input is compared at block 360.

Arrow 602 crosses the downshift threshold between the fifth and fourth gears in the first shift map 400. Arrow 604 crosses the downshift threshold between the sixth and fifth gears. Arrow 606 the downshift threshold between the sixth and fifth gears. Arrow 608 does not cross any downshift thresholds and remains within the region associated with the eighth gear. Arrow 610 does not cross any downshift thresholds and remains within the region associated with the sixth gear. Arrow 612 crosses the downshift threshold between the eighth and seventh gears. Arrow 614 crosses the downshift threshold between the seventh and sixth gears. Arrow 616 crosses the downshift threshold between the eighth and seventh gears.

FIG. 10A illustrates an example of downshift thresholds of the third shift map 700. The speed parameter, ω, is shown on the x-axis with respect to accelerator input, a, on the y-axis. In this example the third shift map 700 is for the same eight-speed transmission as the first shift map 400 illustrated in FIGS. 6 and 9. In the third shift map 700, however, only five distinct downshift thresholds can be seen. This is because two of the downshift thresholds are defined by a common function and another two of the downshift thresholds are defined by another common function.

The right-most of these lines represents both the downshift threshold for triggering a downshift out of the eighth gear into the seventh gear and the downshift threshold for triggering a downshift out of the seventh gear into the sixth gear, yielding an effective downshift threshold for triggering a downshift out of the eighth gear into the sixth gear. This effective downshift threshold is associated with a gear skip over the seventh gear. Accordingly, crossing this effective downshift threshold can trigger a downshift from the eighth gear to the sixth gear, skipping over the seventh gear.

In this example, the common function defining the downshift threshold between the eighth and seventh gears according to the third shift map 700 and defining the downshift threshold between the seventh and sixth gears according to the third shift map 700 is identical to the function defining the downshift threshold between the eighth and seventh gears according to the first shift map 400.

The next line to the left represents both the downshift threshold for triggering a downshift out of the sixth gear into the fifth gear and the downshift threshold for triggering a downshift out of the fifth gear into the fourth gear, yielding an effective downshift threshold for triggering a downshift out of the sixth gear into the fourth gear. This effective downshift threshold is associated with a gear skip over the fifth gear. Accordingly, crossing this effective downshift threshold can trigger a downshift from the sixth gear to the fourth gear, skipping over the fifth gear.

In this example, the another common function defining the downshift threshold between the sixth and fifth gears according to the third shift map 700 and defining the downshift threshold between the fifth and fourth gears according to the third shift map 700 is identical to the function defining the downshift threshold between the eighth and seventh gears according to the first shift map 400 until the maximum value of the speed parameter at which a downshift between the sixth and fifth gears can be triggered according to the first shift map 400 is reached. The another common function is then invariant with higher accelerator inputs.

As a result, the common function and the another common function are identical below a particular value of the accelerator input and then diverge above this particular value.

The next line again to the left represents the downshift threshold for triggering a downshift out of the fourth gear into the third gear.

In this example, the function defining the downshift threshold between the fourth and third gears according to the third shift map 700 is identical to the function defining the downshift threshold between the sixth and fifth gears according to the first shift map 400 until the maximum value of the speed parameter at which a downshift between the fourth and third gears can be triggered according to the first shift map 400 is reached. The function defining the downshift threshold between the fourth and third gears according to the third shift map 700 is then invariant with higher accelerator inputs.

The two left-most lines represent the downshifts into the second and first gears respectively. In some examples these are defined by the same functions as respectively defined corresponding downshift thresholds in the first shift map 400.

A number of x-shaped markers 702-716 respectively represent the points within the parameter space described by the end of the arrows 602-616 illustrated in FIG. 9. Since the rate of increase in accelerator input represented by the arrows 602-616 exceeds the another, lower threshold rate, in accordance with the method 300, the active shift map can be changed from the first shift map 400 to the third shift map 700 if these increases also result in the crossing of a downshift threshold in the first shift map 400. If the active shift map is changed to the third shift map 700, it is the gear ratio associated with the region of the third shift map 700 in which the described point lies upon which the destination gear is based.

Marker 702 lies within the region associated with the third gear in the third shift map 700. In response to the increase represented by arrow 602 therefore, the proposed shift is from the fifth gear to the third gear. The method 300 therefore achieves a benefit of an additional step in the gear ratio change as compared with conventional control according to only the first shift map 400.

Marker 704 lies within the region associated with the third gear. In response to the increase represented by arrow 604 therefore, the proposed shift is from the sixth gear to the third gear. The method 300 therefore achieves a benefit of two additional steps in the gear ratio change as compared with conventional control according to only the first shift map 400.

Marker 706 lies within the region associated with fourth gear. In response to the increase represented by arrow 606 therefore, the proposed shift is from the sixth gear to the fourth gear. The method 300 therefore achieves a benefit of an additional step in the gear ratio change as compared with conventional control according to only the first shift map 400.

Marker 708 lies within the region associated with eighth gear. In response to the increase represented by arrow 608 therefore, no shift is proposed. As the increase represented by arrow 608 did not cross any downshift thresholds in the first shift map 400, the active shift map also remains the first shift map 400. It will be observed that the increase represented by arrow 408, having similar starting values for the accelerator input and speed parameter, triggered a change in the active shift map to the second shift map 500 accompanied by a gear ratio change of four steps. This example highlights an advantage of the second shift map 500 over the third shift map 700.

Marker 710 lies within the region associated with the fourth gear in the third shift. However, as the increase represented by arrow 610 did not cross any downshift thresholds in the first shift map 400, the active shift map remains the first shift map 400 and no shift is proposed from the sixth gear. This example highlights an advantage of the entry conditions into the second mode over the entry conditions into the third mode. If crossing a downshift threshold in the first shift map 400 was not a condition for entry into the third mode (as it is not for entry into the second mode), then the increase represented by the arrow 610 would have achieved a benefit of an additional step in the gear ratio change as compared with conventional control according to only the first shift map 400. As it is, no such benefit is achieved.

Marker 712 lies within the region associated with fourth gear. In response to the increase represented by arrow 612 therefore, the proposed shift is from the eighth gear to the fourth gear. The method 300 therefore achieves a benefit of three additional steps in the gear ratio change as compared with conventional control according to only the first shift map 400.

Marker 714 lies within the region associated with sixth gear. In response to the increase represented by arrow 614 therefore, the proposed shift is from the seventh gear to the sixth gear. In this instance, the method 300 does not achieve an immediate benefit upon switching (block 380) as compared with conventional control according to only the first shift map 400, however, benefits will arise from continuing control of the automatic transmission 12 according to the third shift map 700 (block 390).

Marker 716 within the region associated with sixth gear. In response to the increase represented by arrow 616 therefore, the proposed shift is from the eighth gear to the sixth gear. The method 300 therefore achieves a benefit of an additional step in the gear ratio change as compared with conventional control according to only the first shift map 400.

It will therefore be observed that, though the method 300 still achieves significant benefits over continued operation in the first mode by providing a path (blocks 360 to 380) to entry into the third mode and operation in the third mode (block 390), the benefits are less than achieved by providing a path (blocks 330 to 340) to entry into the second mode and operation in the second mode (block 350).

FIG. 10B illustrates one example of upshift thresholds of the same third shift map 700. The speed parameter, ω, is shown on the x-axis with respect to accelerator input, a, on the y-axis. Seven upshift thresholds are shown. The left-most of these lines represents the upshift threshold for triggering an upshift out of the first gear (lowest gear ratio) and the right-most of these lines represents the upshift threshold for triggering an upshift into the eighth gear (highest gear ratio). Intervening lines successively represent upshift thresholds for triggering upshifts from the second gear through to the seventh gear.

In this example, each upshift threshold for the speed parameter, from first gear to eighth gear, varies with accelerator input.

In this example, the upshift thresholds for triggering upshifts from the first and second gears are defined by the same functions as define corresponding upshift thresholds in the first shift map 400.

In this example, the upshift threshold for triggering upshifts from the seventh gear into the eighth gear is defined by the same function as defines the corresponding upshift threshold in the first shift map 400.

In this example, each of the upshift thresholds for triggering upshifts from the third gear through to the seventh gear are identical to the upshift threshold for triggering upshifts from the seventh gear into the eighth gear until respective maximum values of the speed parameter at which corresponding upshifts can be triggered according to the first shift map 400 are reached. These upshift thresholds are then invariant with higher accelerator inputs.

In general, each of the upshift thresholds in the third shift map 700 may be unique. The third shift map 700 may define a unique set of upshift points for each upshift. At least some of the upshift thresholds may coincide with one another for a range of accelerator inputs. Upshift points may, for example, be shared between at least two upshifts at low accelerator inputs. Upshift points associated with these at least two upshifts diverge at higher accelerator inputs.

In another example, upshift thresholds of the third shift map 700 resemble those illustrated in and described in relation to FIG. 7B. That is, they are similar to those of the second shift map 500. In examples where the upshift thresholds of the third shift map 700 are otherwise similar to those of the second shift map 500, they may differ in that at least some of the upshift thresholds of the second shift map 500 are set at higher values of the speed parameter, for all or at least some accelerator inputs, than the corresponding upshift thresholds of the third shift map 700.

In the foregoing, it has been assumed that the first shift map 400 is the one from the set of first shift maps which has the highest residency during normal driving. That is, it is the one which is the most often active during normal driving. In the case that it is not, all aspects of the third shift map 700 which have been described or defined in relation to the first shift map 400 may additionally or alternatively be understood as being described or defined in relation to the one from the set of first shift maps which does have the highest residency during normal driving.

FIGS. 10A and 10B have illustrated a third shift map 700 that can be used to control the automatic transmission 12 in the third mode entered at block 380 of the method 300. However, it will be appreciated that this third shift map 700 could be used to control the automatic transmission 12 in the second mode entered at block 340 of the method 300 in place of the second shift map 600 illustrated in FIGS. 7A and 7B.

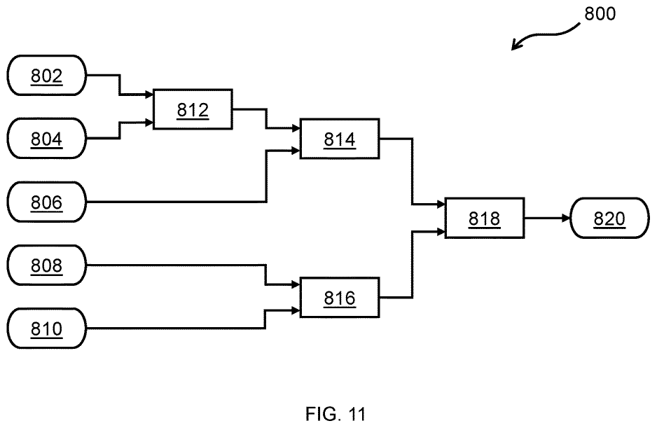

FIG. 11 illustrates an example of a method 800 for determining the threshold rate against which the rate of increase in accelerator input is compared at block 330 of the method 300. The method 800 may be performed as a submethod of method 300 during block 310.

The method 800 comprises receiving at least some of the following as input parameters:
a current accelerator input, received at block 802;
a rolling mean of the accelerator input, received at block 804;
a gear ratio currently proposed by the first shift map 400, received at block 806
a current road load, received at block 808; and
a current evaluation of a driving style of the driver, received at block 810.

These input parameters may be indicated by signals received by the control system 100 or may be output parameters from another method performed by the control system 100. They may therefore be received from an external source (with respect to the to the control system 100) or have an internal source.

Block 814 comprises determining a first threshold for a rate of increase in accelerator input.

In some examples, the first threshold is determined based on the current accelerator input (received at block 802). The first threshold may be determined from a lookup table stored in the memory 108 of the control system 100 which defines different thresholds for a rate of increase in accelerator input in association with different starting values for the accelerator input. Accordingly, the current accelerator input may be used as an index to the lookup table to extract the threshold for a rate of increase in accelerator input starting from the current accelerator input. The thresholds for a rate of increase in accelerator input may be lower when the starting values of the accelerator input are higher. This may be particularly advantageous where the accelerator input is derived from depression of an accelerator pedal because if a driver is already depressing the pedal, there is a limit to how fast the pedal can move, subsequently limiting the rate of increase in accelerator input. In contrast, when the driver is not depressing the pedal, they can accelerate their foot before it begins to depress the pedal, allowing higher rates of increase in accelerator input to be achieved.

In other examples, the first threshold is determined based on a difference between the current accelerator input (received at block 802) and the rolling mean of the accelerator input (received at block 804). The rolling mean is a mean of the accelerator input during a rolling period having a fixed duration. The difference between the current accelerator input and the rolling mean of the accelerator input can be calculated by subtracting the rolling mean of the accelerator input from the current accelerator input; however, it will be set to zero when the rolling mean of the accelerator input is greater than the current accelerator input. In these examples, the difference between the current accelerator input and the rolling mean of the accelerator input may be determined at block 812. Alternatively, it may be received as an input parameter into the method 800. In these examples, the first threshold may still be determined from a lookup table stored in the memory 108 of the control system 100, however this lookup table defines different thresholds for a rate of increase in accelerator input in association with different differences between the current accelerator input and the rolling mean of the accelerator input. As in the foregoing example, the thresholds for a rate of increase in accelerator input may be lower when the starting values of the accelerator input are higher.

In some examples, the first threshold is further based on the gear ratio currently proposed by the first shift map 400 (received at block 806). The aforementioned lookup tables may be modified to include a second dimension in which different thresholds for a rate of increase in accelerator input are defined in association with different gear ratios. The thresholds for a rate of increase in accelerator input may be higher when gear ratio currently proposed by the first shift map 400 is lower.

In some examples, the first threshold provides the threshold rate against which the rate of increase in accelerator input is compared at block 330 of the method 300. It is therefore provided as an output parameter of the method 800 at block 820. It will be understood that this output parameter forms an input parameter for another block in the method 300 (specifically block 330) and is not an output from the control system 100.

In other examples, the first threshold represents a base threshold which may be further tuned to account for one or more of the driving style of the driver and road load. To this end, block 814 comprises determining an offset based on one or more of the driving style of the driver and the road load which is then summed with the first threshold (from block 812) at block 816 to provide the threshold rate against which the rate of increase in accelerator input is compared at block 330 of the method 300.

The offset may be determined (at block 814) from a further lookup table stored in the memory 108 of the control system 100 which defines offsets in association with different evaluations of a driving style of the driver (in a first dimension) and in association with different road loads (in a second dimension). The current road load (received at block 808) and the current evaluation of a driving style of the driver (received at block 810) may be used as an index to the further lookup table to extract the corresponding offset.

In some examples, the offset may be multiplied by a factor based on a current value of a speed parameter, which may be the same or different to the speed parameter which is an input parameter to the shift maps. For example, while the speed of the transmission output shaft 20 may be used as an input parameter to the shift maps, the multiplication factor applied to the offset may be based on the speed of the transmission input shaft 18.

The lookup tables used in the method 800 may be derived from experimental data, theoretical modelling, or a combination thereof.

An equivalent method using differently calibrated lookup tables may be used to determine the another, lower threshold rate against which the rate of increase in accelerator input is compared at block 360 of the method 300.

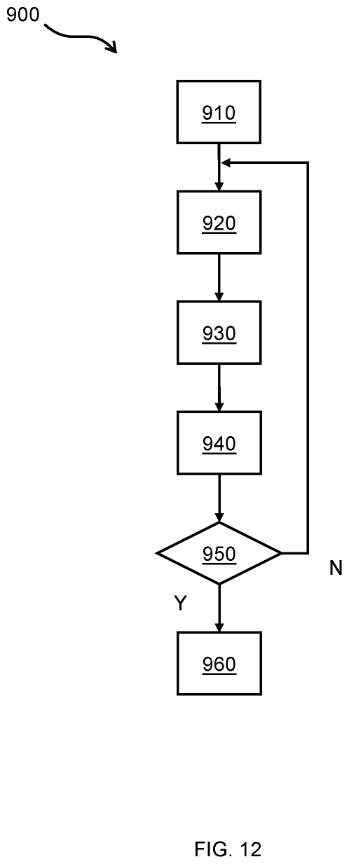

FIG. 12 illustrates an example of a method 900 of controlling the automatic transmission 12 of the vehicle 1. The method 900 may be performed by the control system 100 illustrated in FIG. 3. In particular, the memory 108 may comprise computer-readable instructions 110 which, when executed by the processor 106, perform the method 900.

The method 900 relates to exit from a mode of controlling the automatic transmission 12 in which its response times to rapid increases in accelerator input are improved. It involves switching from a second mode back into the first mode described in the foregoing. In this example, the second mode which is exited may correspond to either the second mode or the third mode described in the foregoing. The methods for exiting both of these modes are generally the same, though may differ in the threshold values which must be exceeded.

Block 910 comprises initial operation in the second mode. In this second mode, the automatic transmission 12 is controlled according to either the second shift map 500 described in the foregoing or the third shift map 700 described in the foregoing. The second (or third) shift map 500, 700 is the active shift map in this second mode.

As described in the foregoing, downshift thresholds in the second (and third) shift maps 500, 700 are invariant with changing road load.

Block 920 comprises receiving one or more signals indicative of a current road load.

As described in the foregoing, road load may be calculated from one or more estimated vehicle mass, estimated slope (road gradient), estimated aerodynamic resistance, and estimated rolling resistance, which may each be indicated by signals received by the control system 100. Alternatively, road load may be indicated directly by a signal received by the control system 100. Road load as herein calculated may comprise a variance between the road load for the unladen vehicle travelling on a level road and the road load comprising one or more of the above factors which may change during operation of the vehicle.

Block 930 comprises determining, based on the current road load, an exit threshold for the speed parameter. The exit threshold is a threshold which, when crossed by the current value of the speed parameter, triggers an exit from the second mode.

In some examples, the exit threshold is invariant with accelerator input, or is invariant with accelerator input at least where the accelerator input is below a maximum value of the accelerator input achievable without kickdown (not shown) in the case of input derived from accelerator pedal depression. In other examples, the exit threshold varies with accelerator input.

### The Exit Threshold May Be Calibrated Relative to an Upshift Threshold in the Active Shift Map 500, 700.

Accordingly, where the active shift map is the second shift map 500 described in the foregoing, depending on the upshift threshold relative to which the exit threshold is calibrated, the exit threshold might be invariant with accelerator input, or be invariant with accelerator input at least where the accelerator input is below a maximum value of the accelerator input achievable without kickdown (not shown) in the case of input derived from accelerator pedal depression. In contrast, where the active shift map is the third shift map 700 described during the foregoing, the exit threshold might vary with accelerator input.

In some examples, the exit threshold is calibrated relative to the upshift threshold in the second (or third) shift map 500, 700 associated with triggering an upshift into the highest gear ratio. When the current road load corresponds to driving on the flat (0% gradient), the exit threshold may correspond to the upshift threshold in the second (or third) shift map 500, 700 associated with triggering the upshift into the highest gear ratio. When the current road load corresponds to driving uphill (>0% gradient), the exit threshold may comprise higher values of the speed parameter for all accelerator inputs, or for at least a range of accelerator inputs, as compared to the upshift threshold in the second (or third) shift map 500, 700 associated with triggering the upshift into the highest gear ratio.

In other examples, a plurality of exit thresholds are calibrated relative to each of the upshift threshold in the second (or third) shift map 500, 700. The utilised exit threshold is then selected to be the one calibrated relative to the upshift threshold in the second (or third) shift map 500, 700 associated with triggering an upshift into the next higher gear ratio (to the current gear ratio). When the current road load corresponds to driving on the flat, the exit threshold may correspond to the upshift threshold in the second (or third) shift map 500, 700 associated with triggering the upshift into the next higher gear ratio. When the current road load corresponds to driving uphill, the exit threshold may comprise higher values of the speed parameter for all accelerator inputs, or for at least a range of accelerator inputs, as compared to the upshift threshold in the second (or third) shift map 500, 700 associated with triggering the upshift into the next higher gear ratio.

In some examples, the exit threshold is calibrated relative to the first shift map 400 which would be used at the current road load. For example, the exit threshold can be calibrated so that, on exiting the second mode in favour of the first mode, the first shift map 400 which would be used at the current road load would not propose a gear shift or would propose only an upshift of a single step.

Block 940 comprises receiving a signal indicative of a current value of the speed parameter. In at least those examples which involve an exit threshold which varies with accelerator input, block 940 further comprises receiving a signal indicative of the current accelerator input.

Block 950 comprises determining whether the current value of the speed parameter exceeds the exit threshold. If the exit threshold varies with accelerator input, block 950 comprises determining whether the current value of the speed parameter exceeds the exit threshold at the current accelerator input.

In some examples blocks 930 to 950 may be implemented using a lookup table of calibrated exit speeds. The lookup table comprises specific values for the road load that index a first dimension of the lookup table and, in some examples, may comprise specific values for the accelerator input that index a second dimension of the lookup table. Accordingly, the current road load and, in some examples, the current accelerator input may be used to extract a corresponding exit speed. If an exit speed associated with an intermediate value of the road load (or accelerator input) is needed, interpolation between the calibrated exit speeds can be used to estimate this exit speed. The calibrated exit speeds are larger when the road load is greater. This ensures that operation continues longer in the second mode, which provides a more aggressive shifting strategy, whilst working against greater road loads. The calibrated exit speeds may also be larger when the accelerator input is higher.

If the current value of the speed parameter exceeds the exit threshold (‘Y’ path from block 950), the method 900 advances to block 960. Block 960 comprises switching from operating in the second mode to operating in the first mode. Operation in the first mode is as described in relation to block 310 of method 300.

If the current value of the speed parameter does not exceed the exit threshold (‘N’ path from block 950), there is no exit from the second mode. The second mode may however be exited if current value of the speed parameter does not exceed the exit threshold within a predefined period of time of beginning operation in the second mode (at blocks 340 or 380). The predefined period of time may be selected from several options based on which of the second or third shift maps 500, 700 is active and based on the longitudinal acceleration of the vehicle 1. The second mode may also be exited if the vehicle's brakes are actuated.

To prevent rapid switching back into the second mode after it has been exited, a pre-condition for entry into the second mode may be set. In some examples, this comprises preventing switching from the first mode to the second mode while a current value of the speed parameter is above the exit threshold associated with the current accelerator input. In some examples, hysteresis may be added by requiring that the current value of the speed parameter is a variable amount lower than the exit threshold associated with the current accelerator input. The variable amount can be dependent on the current road load and the current accelerator input.

As used herein, the term ‘obtain/obtaining’ (and grammatical variants thereof) can include, not least: calculating, computing, processing, deriving, measuring, investigating, identifying, looking up (for example, looking up in a table, a database or another data structure), ascertaining and the like. Also, ‘obtain/obtaining’ can include receiving (for example, receiving information), accessing (for example, accessing data in a memory), determining and the like. Also, ‘obtain/obtaining’can include resolving, selecting, choosing, establishing, and the like.

It will be appreciated that embodiments of the present invention can be realised in any suitable form of hardware, software or a combination of hardware and software. For example, it is contemplated that the present invention is not limited to being implemented by way of programmable processing devices, and that at least some of, and in some embodiments all of, the functionality and or method steps of the present invention may equally be implemented by way of non-programmable hardware, such as by way of non-programmable ASIC, Boolean logic circuitry, etc.

It will be appreciated that various changes and modifications can be made to the present invention without departing from the scope of the present application.

For purposes of this disclosure, it is to be understood that reference to ‘the control system being configured to’ is to be understood to mean ‘the one or more controllers of the control system are collectively configured to’. The controller(s) described herein can each comprise a control unit or computational device having one or more electronic processors, the one or more processors collectively configured to perform the control system functionality set out in the control system claims.

The blocks illustrated in the FIGS. 5 to 12 may represent steps in a method and/or sections of code in the computer program 110. The illustration of a particular order to the blocks does not necessarily imply that there is a required or preferred order for the blocks and the order and arrangement of the block may be varied. Furthermore, it may be possible for some steps to be omitted.

Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not.

1. A control system for an automatic transmission of a vehicle, the control system comprising one or more controllers, the control system configured to:
in a first mode, control the automatic transmission according to a first shift map which defines downshift thresholds for a speed parameter as functions of accelerator input, wherein each downshift threshold is defined by a unique function;
in a second mode, control the automatic transmission according to a second shift map which defines downshift thresholds for the speed parameter as functions of accelerator input, wherein at least two downshift thresholds are defined by a common function;
receive a signal indicative of a rate of increase in accelerator input; and
switch from the first mode to the second mode, in dependence on the rate of increase in accelerator input exceeding a threshold rate, and regardless of whether a downshift threshold of the first shift map is crossed.

2. The control system of claim 1, wherein the control system is configured to determine the threshold rate based on a current accelerator input.

3. The control system of claim 1, wherein the control system is configured to determine the threshold rate based on a difference between the current accelerator input and a rolling mean of the accelerator input.

4. The control system of claim 1, wherein the control system is configured to determine the threshold rate based on the gear ratio currently proposed by the first shift map.

5. The control system of claim 1, wherein the threshold rate is higher than another threshold rate which is associated with switching mode away from the first mode when a downshift threshold in the first shift map is crossed.

6. The control system of claim 1, wherein the at least two downshift thresholds defined by the common function represent a downshift between two non-adjacent gear ratios which can be performed as a direct shift by automatic transmission hardware.

7. The control system of claim 1, wherein at least two other downshift thresholds in the second shift map are defined by another common function.

8. The control system of claim 1, wherein at least two downshift thresholds defined by the common function in the second shift map have higher values of the speed parameter for a range of accelerator inputs as compared to corresponding downshift thresholds in the first shift map.

9. The control system of claim 8, wherein at least some other of the downshift thresholds in the second shift map have higher values of the speed parameter for a range of accelerator inputs as compared to corresponding downshift thresholds in the first shift map.

10. The control system of claim 1, wherein the at least two downshift thresholds defined by the common function are invariant with accelerator input.

11. The control system of claim 10, wherein at least some other of the downshift thresholds in the second shift map are invariant with accelerator input.

12. An automatic transmission system comprising the control system of claim 1, and an automatic transmission.

13. A vehicle comprising the automatic transmission system of claim 12.

14. A method of controlling an automatic transmission of a vehicle, the method comprising:
in a first mode, controlling the automatic transmission according to a first shift map which defines downshift thresholds for a speed parameter as functions of accelerator input, wherein each downshift threshold is defined by a unique function;
in a second mode, controlling the automatic transmission according to a second shift map which defines downshift thresholds for the speed parameter as functions of accelerator input, wherein at least two downshift thresholds are defined by a common function;
receiving a signal indicative of a rate of increase in accelerator input; and
switching from the first mode to the second mode, in dependence on the rate of increase in accelerator input exceeding a threshold rate, and regardless of whether a downshift threshold of the first shift map is crossed.

15. Computer readable instructions which, when executed by a computer, are arranged to perform a method according to claim 14.
